(19) United States
(12) Patent Application Publication
(10) Pub. No.: US 2002/0112247 A1
(43) Pub. Date: Aug. 15, 2002

(54) Method and system for creation, delivery, and presentation of time-synchronized multimedia presentations

(76) Inventors: David R. Horner, Palo Alto, CA (US); Jonathan W. Brandt, Santa Cruz, CA (US)

Correspondence Address: GARY CARY WARE & FREIDENRICH LLP, 1755 EMBARCADERO ROAD, PALO ALTO, CA, 94303-3340, US

(21) Appl. No.: 10/071,568

(22) Filed: Feb. 8, 2002

Related U.S. Application Data
(60) Provisional application No. 60/267,848, filed on Feb. 9, 2001.

(51) Int. Cl. G06F 3/00; H04N 5/445; G06F 13/00; H04N 7/173; H04N 7/16

(52) U.S. Cl. 725/112; 725/110; 725/51; 725/135; 725/136

(57) ABSTRACT

The present invention relates to the composition of synchronized media experiences, the coordination of multiple composers and publication in a production environment, the serving of these publications either immediately at creation time or at a later time, and finally, the distribution of these publications to possible a very large number of device users. One characteristic of the invention is that compositions can be device independent, targeting a wide variety of media capable devices at publication, distribution, or viewing time. Another characteristic is that a content provider can deliver media such as video, content, and commerce opportunities through any combination distribution methods and user devices simultaneously. Yet another feature is that a live event that is published through the present invention can be played back on demand or rebroadcast without any additional work on the part of the publisher. A design point in the architecture is that the mechanisms of media synchronization are distinctly separate from the content (either static or streaming). This separation offers modularity with respect to digital content and allows the invention to work with a wide variety of media formats and technologies, such as time-coded references (e.g. eXtensible Markup Language, or XML) to synchronize media content.

The present application claims the priority of a provisional application Serial No. 60/267,848 filed on Feb. 9, 2001.

### TECHNICAL FIELD

This invention relates generally to multimedia presentation apparatus and methods in a networked computer environment and more particularly to the creation, management, delivery and presentation of multimedia objects in a networked environment.

### BACKGROUND OF THE INVENTION

Devices that can present electronic media are becoming more sophisticated and commonplace every day. Televisions, personal computers, entertainment centers, internet-enabled wireless phones, handheld computers, and portable game players are just a few examples. Many of these devices can present more than one electronic media at a time (for example, a web page with sounds and changing images). In addition, it is often desirable to have multiple devices working together to provide an enhanced user experience (for example, watching a television broadcast, while interacting with supplement material in a web browser on a PC).

Many media capable devices available today also provide the ability for the user to interact with the digital media and even to access associated connected services. For example, web browsers running on personal computers allow a user to search through pictures of snowboards, select one for purchase, and complete the sales transaction. The use of streaming media could greatly enhance this experience, however, by showing the product in use and increasing the motivation to buy. Add to that a voice-over that educates the buyer to purchase the most suitable model, and you have a very powerful experience.

There are many problems associated with the present technique of presenting synchronized multimedia. First, most methods for synchronizing content to video or audio streams consists of adding triggers into the streaming media at authoring time, making it difficult to support multiple streaming formats and very difficult to make changes without re-authoring/re-encoding the media.

In addition, alternate methods of synchronizing content put the triggers directly into the textual content which also causes issues for multiple platforms as well as changes to the synchronization triggers. Another common problem with today's method is leveraging the same synchronization data with multiple delivery devices and formats requires the re-authoring of the multi-media experience for each device and format.

The present invention is a solution to that problem.

### SUMMARY OF THE INVENTION

In essence, the present invention supports the composition of synchronized media experiences, the coordination of multiple composers and publication in a production environment, the serving of these publications either immediately at creation time or at a later time, and finally, the distribution of these publications to possible a very large number of device users.

One characteristic of the invention is that compositions can be device independent, targeting a wide variety of media capable devices at publication, distribution, or viewing time.

Here are a few examples of the preferred embodiment:

1. Internet Audio or Video—Both On-Demand and Live Web-Casts delivered over the Internet to a standard media player embedded in a web browser are supported. Images and text displayed outside the player (in other frames or windows) are synchronized to the primary streaming media.

2. Radio or Television Broadcast—This primary media stream can be synchronized with the “two-device method.” That is a radio or television broadcast is synchronized with dynamic content on a personal computer or wireless device. Internet TV is supported in a “one-device” experience, also.

One feature of the present invention is that a content provider can deliver media such as video, content, and commerce opportunities through any combination distribution methods and user devices simultaneously. Another feature is that a live event that is published through the present invention can be played back on demand or rebroadcast without any additional work on the part of the publisher.

A design point in the architecture is that the mechanisms of media synchronization are distinctly separate from the content (either static or streaming). This separation offers modularity with respect to digital content and allows the invention to work with a wide variety of media formats and technologies. The present invention employs time-coded references (described in the eXtensible Markup Language, or XML) to synchronize media content.

The present invention separates synchronization information from presentation information. This unique property of SMS (Synchronous Media System) is distinct from other emerging standards, such as SMIL (Synchronized Multimedia Integration Lnaguage), in which media element presentation (including spatial arrangement, format selection, layering, etc.) and the time-sequencing of those elements are combined in a single descriptive structure.

The actual synchronized content may exist in several different forms and originate from a variety of sources:

1. On Demand Video: Digital video content can be stored online for on-demand streaming to the end-user. A single video file may be stored in multiple formats (Windows Media, Real, QuickTime, etc.) and in multiple bit-rates (56 k, 100 k, 300 k, 600 k, etc.) but it need only be synchronized once since the XML providing the synchronization is stored external to the video.

2. Standard Web Content: Any type of rich text (HTML), images (JPEG), audio (MPEG3), scripting (JavaScript), portable programming (Java), or other digital instructions that can be interpreted by an advanced web browser, can be incorporated into a media synchronization experience.

3. Live Television or Webcast: Live analog or digital video content that is being broadcast or streamed in multiple formats and transfer rates can be synchronized “live”. The resulting multi-media composition can be stored for future “on-demand” playback at any time.

### BRIEF DESCRIPTION OF THE DRAWINGS

FIG. 1 illustrates several viewer templates and platforms from the preferred embodiment of the present invention.

FIG. 2 is a Unified Modeling Language (LML) model of the Containment SynchroElements.

FIG. 3 is a UML model of the ActionTargets.

FIG. 4 is a UML model of the ActionItems.

FIG. 5 is a UML model of the Chronograms, Tracks, and Journals.

FIG. 6 is a UML model of the Shows.

FIG. 7 is a detailed flowchart to show how SynchroOperators are processed within the SMS system.

FIG. 8 illustrates a Sample Track.

FIG. 9 shows a high level diagram of the major components of the SMS system.

FIG. 10 is a flow diagram depicting one example of the distribution path of a Live Show.

FIG. 11 is a drawing of a Viewer template (viewerdoc).

FIG. 12 is a drawing of a sample Composer screen showing the functional panels in the user interface.

### DETAILED DESCRIPTION OF THE INVENTION

The present invention will now be described in detail with reference to the preferred embodiment as illustrated in the accompanying drawings. In the following description, numerous specific details are set forth. It will be apparent to one skilled in the art that the present invention may be practiced without some or all of these specific details. In other instances, well known process steps have not been described in detail in order to not unnecessarily obscure the present invention.

The present invention will be referred to as the Synchronous Media System or SMS for short for the remainder of this detailed description.

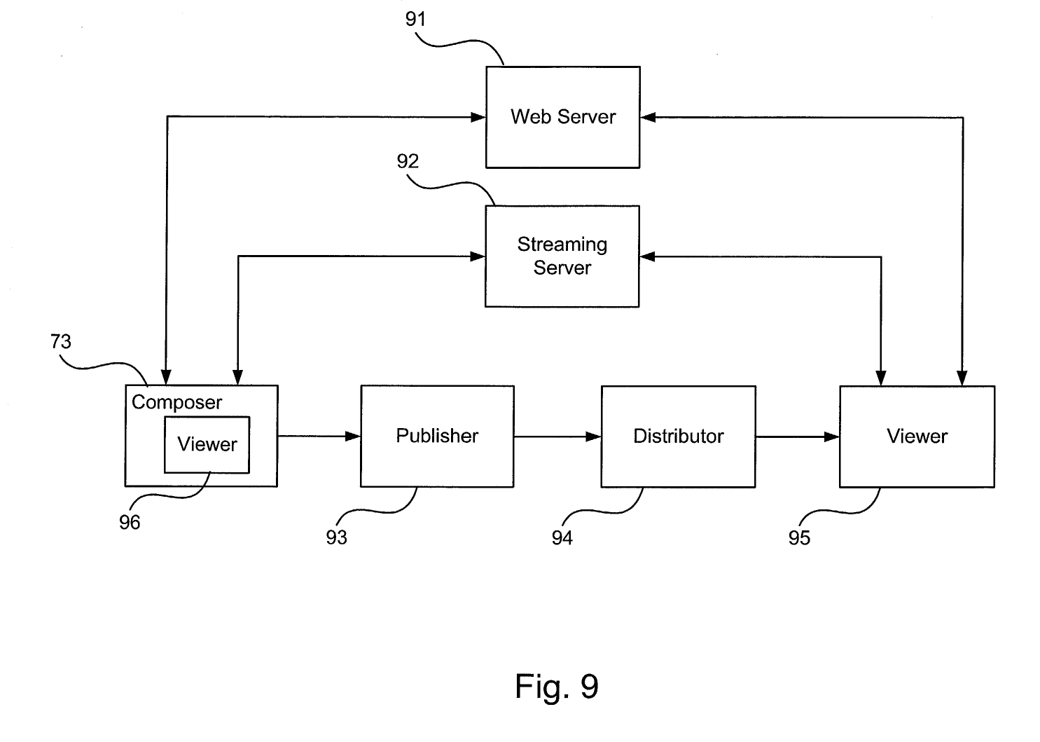

Referring to FIG. 9, there is shown a high level schematic overview of the SMS system of the present invention. The diagram illustrates a logical view of the major components, each of which are described in detail in the subsequent sections.

The major SMS components are briefly described as:

1. Composer 73—Using the Composer 73 platform, professionals specify the coordinated synchronization of streaming and static media that is either created co-incident with synchronization (such as a “live” sporting event) or was created previously and stored for future use.

2. Publisher 93—The Publisher 93 coordinates the management of multiple Composers 73, supporting a production and publication process.

3. Distributor 94—The SMS Distributor 94 provides the source of synchronous media instructions for either an “on-demand” or “live” experience. The SMS Distributor 94 provides the ability to simultaneously deliver a related SMS experience to very large numbers of Viewers 95, over a communication network such as the Internet.

4. Viewer 95—The Viewer 95 component is resident within a hardware device allows synchronized media to be experienced.

The major components that are external to the SMS, but required for the complete synchronous media experience are:

1. Web Servers 91—Serve up non-streaming web content.

2. Streaming Media Servers 92—Serve up streaming web content.

The SMS Viewer 95 is composed of a Viewer Engine contained within an adaptive software layer, simply called the Engine Container. The Viewer Engine is composed of a realization of the SynchroOperators described hereinafter. The Engine Container interfaces with the encapsulating media management environment (software, hardware, or both).

For example, the preferred embodiment of the SMS Viewer 95 on a desktop computer is a JavaScript library downloaded into a web browser. The JavaScript library employs the document object model (DOM) capability resident within the web browser to create in-memory objects that have both data and callable methods. Part of this JavaScript library realizes the SynchroOperators, forming the Viewer Engine. The other part of the library forms the Engine Container and is responsible for providing a binding for the Handlers 716 to the ActionTargets 33 (media players, frames, images, text areas, applets, etc.). The Viewer Container also provides an interface to the local clock for external time based synchronization (rather than using the relative timeline of a primary media stream).

Note that this is just one particular embodiment. A feature of the SMS is that Composers 73 can deal with Viewers 95 on a fairly abstract level. Resulting published Shows 64 can be cached in encoding sets that are appropriate for the range of targeted Viewers 95. Suitable Viewer Engines and Engine Containers are preloaded or downloaded to the Viewer 95 media management environment as necessary. Thus a Viewer 95 may be realized as JavaScript, Java, machine specific code, firmware, or even in hardware. Engine Containers could interface to a wide variety of devices, from home entertainment systems to a Bluetooth personal network than includes imaging goggles and earphones.

The SMS Composer 73 is the source of all synchronized media experiences (shows 64). The Composer 73 is an application with an embedded SMS Viewer 96.

There are two basic modes of the Composer 73, post-production and live. The postproduction mode uses pre-recorded media for the primary timeline 82. After publication of a SMS Show 64, this pre-recorded media is either broadcast (or rebroadcast) or made available for on-demand viewing via the Internet. The live mode allows authors to dynamically create the SMS Show 64, in real-time, during a media broadcast or Webcast.

The Composer 73 interface is fundamentally the same for both the live and postproduction modes. This allows the author to simply learn one interface and be able to operate in either mode.

The SMS Composer 73 can be a web-based application served from the SMS Publisher 93. This allows any author from anywhere in the world access to the publication process.

In addition to the support of the SMS Publisher 93, the Composer 73 application has access to any content that is accessible via the authors's intranet or the public Internet.

As an example, a commerce service would allow the author to search and navigate through a taxonomy to find products that they would like to make available to their viewers at particular, contextually sensitive moments in a video. These product opportunities will then be presented to the viewer enabling them to instantly purchase a product without interrupting the synchronized media experience. As a revenue model, the publisher could pay the media provider a percentage of each sale made using the provider's content.

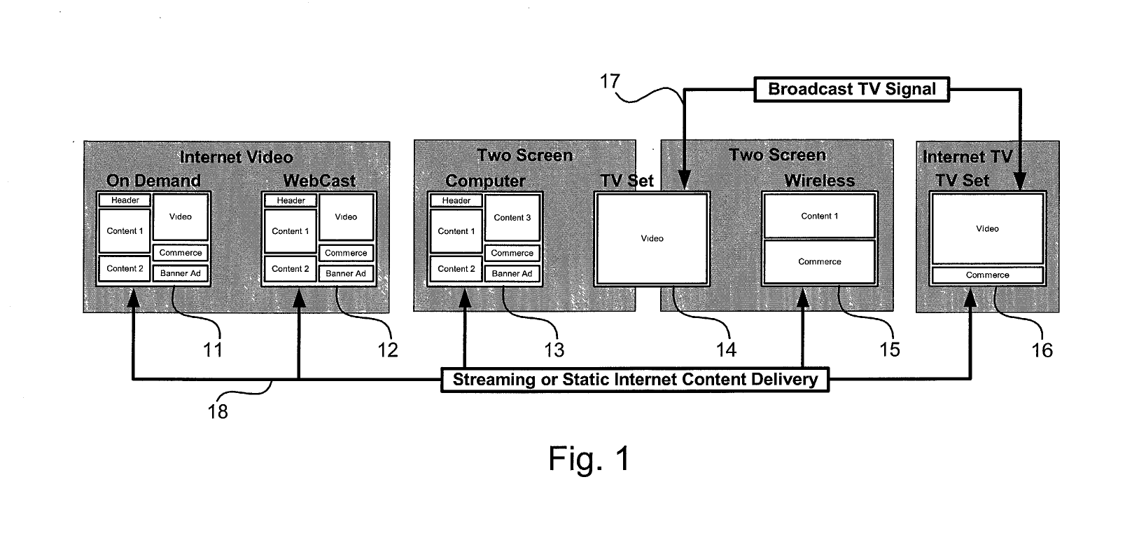

The Viewer component 95 shown in FIG. 1 of SMS interacts with the media-processing environment that allows the user to experience synchronized media. This media processor is, in many cases, a standard web browser (with embedded media players) running on a computer 11, 12, 13, wireless device 15, or set-top box 16.

The following subsections will describe the common aspects of the synchronized media experience as well as the device specific implementations shown in FIG. 1. Note that the SMS allows all of these synchronized media experiences to occur simultaneously to a large population of users employing a wide variety of media processing devices.

1. Internet Browser Interface 11, 12, 13

The preferred embodiment for a single device synchronized media experience on a computer (desktop, set-top, laptop, or handheld) is an industry standard Internet browser.

In the simplest case, the browser will support frames, JavaScript. The user navigates to a web page that downloads the SMS instructions for synchronized media to the Viewer.

In FIG. 1, the user is presented with multiple media frames 11. The video frame would contain a media player that would display the video as it played. The header frame could contain the content provider's logo and site header. The other frames contain content, commerce and banner advertising all of which change based on the context of the video content. The same Internet browser layout can be used for On-Demand 11, Webcast 12, and Two-Screen viewing 13.

In one particular embodiment, the SMS Viewer consists mainly of a JavaScript library that is downloaded with the HTML web page. In the case of a live broadcast, the SMS Viewer also loads a Java Applet from which it will receive the multicast commands and data from the SMS server. Note that this is just an embodiment of the synchronous mechanisms described below, however. The SMS is independent of any particular Viewer environment technology.

2. Wireless Internet Interface 15

The Wireless Internet interface 15 extends the synchronized media experience to mobile devices. In most cases this is in conjunction with a television broadcast, but can also include synchronization with a live event, or with an alternate media stream such as radio.

In many cases the wireless participant 15 will only be presented with a subset of what is available to desktop computer 11, 12, 13 due to the limited screen real estate and transmission bandwidth. The author determines which synchronization tracks are displayed on these scaled down screens.

In FIG. 1, there are only two synchronization tracks being displayed to the viewer 15. The first is the content-1 track and the second the commerce track.

3. Internet TV Interface 16

In the initial preferred embodiment, the Internet television interface will be based on the ATVEF standards developed for Enhanced TV. Most interactive set-top box manufacturers support this standard.

The ATVEF standard is basically an Internet browser spec that supports HTML content and JavaScript. It also defines methods and protocols to multicast information to these browsers in conjunction with the television channel. The ATVEF specification defines a sufficient set of features to support SMS synchronization mechanisms.

The author would decide the layout of the television screen for synchronized media. In FIG. 1, Internet TV Interface 16 shows how commerce opportunities could be added as banners below the video screen. For example, the video could shrink to ¼ of the screen size when the viewer clicks to buy that opportunity.

SynchroElements, which are data elements which move through the SMS are found, for example, in the viewer 95, and are described using the usual object-oriented concepts of type, inheritance (a derived type inherits the characteristics of its base type), containment, and referencing.

SynchroElements, address issues of containment, actions, synchronization, and composition. The preferred embodiment of all SynchroElements is XML (eXtensible Markup Language).

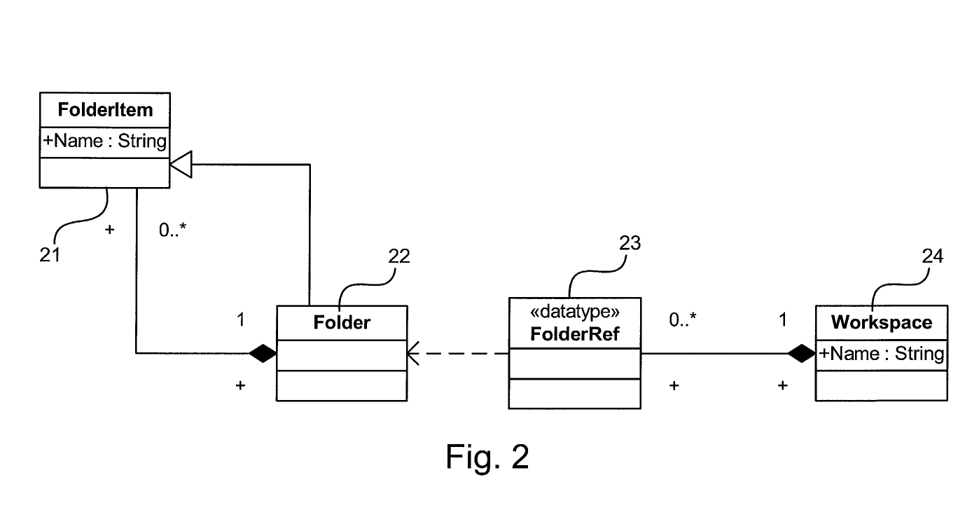

The SMS requires management of a large number of SynchroElements. Thus like management of files on a hard disk or web pages on a website, SynchroElements have the concept of hierarchical organizational containment as shown in FIG. 2.

1. FolderItem 21—The concept of containment is fundamental to SynchroElements, in that it is often necessary for one SynchroElement to contain other SynchroElements. A SynchroElement that can be contained is called a FolderItem 21.

2. Folder 22—A SynchroElement that can contain other SynchroElements (which are therefore FolderItems 21) is called a Folder 22. A Folder 22 may be contained within other Folders 22 and is therefore a FolderItem 21. Folders 22 “own” their contained FolderItems 21. That is, when a Folder 22 is destroyed, all contained FolderItems 21 are also destroyed. This relationship is recursive for contained Folders 22.

3. FolderRef 23—A FolderRef 23 references a Folder 22. That is, a FolderRef 23 contains sufficient information to locate the referenced folder 22. The location information is usually via a URI (uniform resource identifier). If a FolderRef 23 is destroyed, the referenced Folder 22 is not destroyed.

4. Workspace 24—A Workspace 24 is a container of FolderRefs 23. When the Workspace 24 is destroyed, the contained FolderRefs 23 are also destroyed.

FolderRefs 23 and Workspaces 24 allow the same SynchroElement to be included in various logical collections. For example, it may be convenient to include references to several personal and group Folders 22 in a Workspace 24.

Access Control

Folders 22 can be assigned an owner and a group. Default permissions (read, add, delete) based on whether the user is the owner or a member of the assigned group can be stored with the Folder 22. If this mechanism does not provide enough refinement in access control, explicit access control lists (ACLs) can be attached to the Folder 22. Access control information can be stored co-resident with the Folder 22 or externally (such as in the Publisher Directory described below).

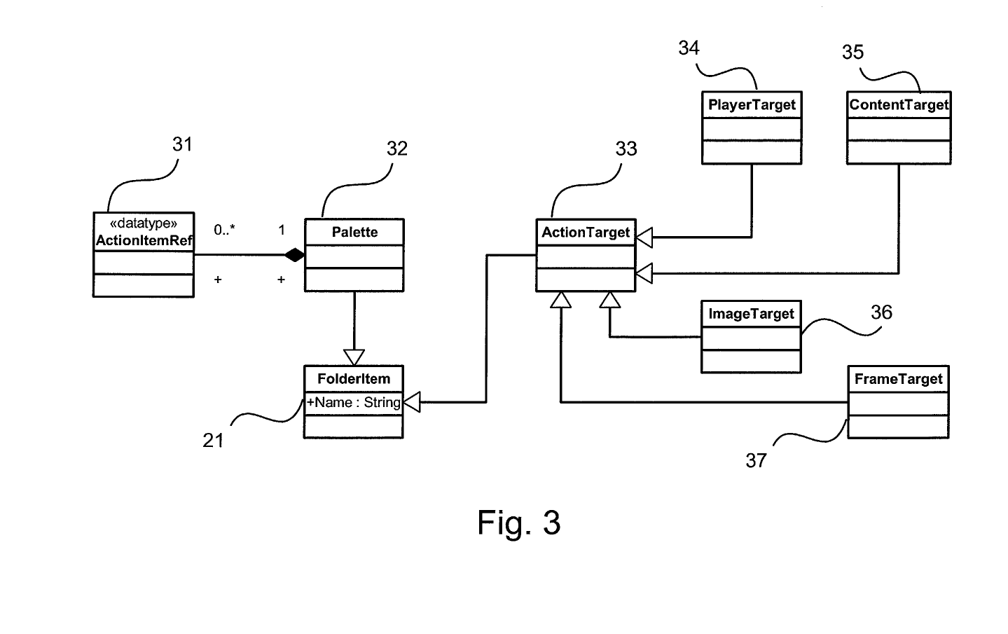

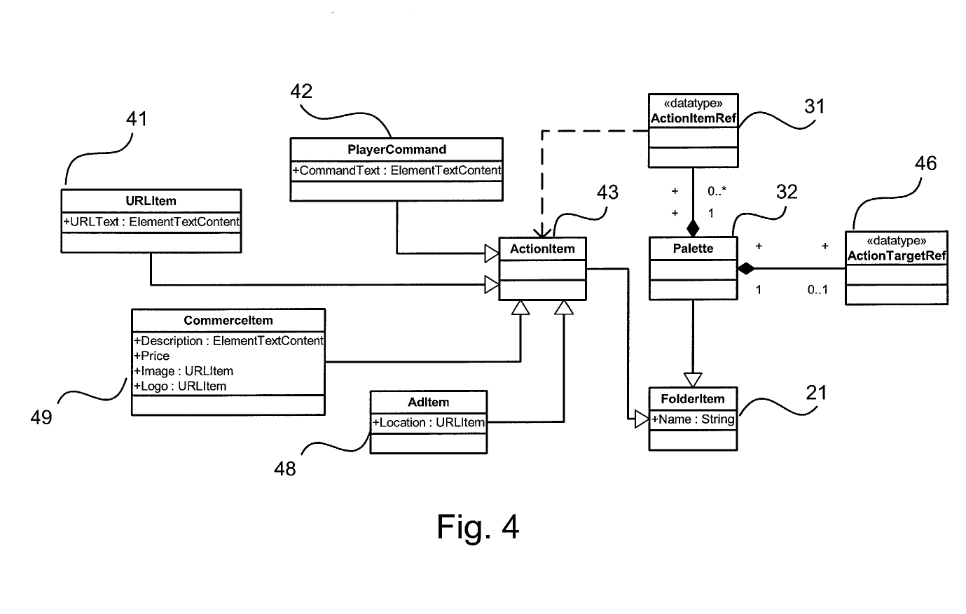

In FIG. 3 and FIG. 4, three FolderItems—ActionTargets 33, ActionItems 43, and Palettes 32, convey the concept of an “action”.

3. ActionTarget 33—An ActionTarget 33 is name and a type that identifies any component of a browser, media device, or media player that accepts commands, parameters, or instructions. Examples of ActionTargets 33 are browser windows or frames 37, HTML image objects 36, embedded media players 34, downloaded Java applets or ActiveX controls, etc 35.

4. ActionItem 43—An ActionItem 43 is a command, parameter, or instruction that can be sent to an ActionTarget 33. Examples of ActionItems 43 are player commands 42 (“pause”, “stop”, “rewind”, etc.), content descriptions 41 (URLs), commerce 49 or advertisement instructions 48 (HTML fragment), etc.

5. ActionItemRef 31—An ActionItemRef 31 is a reference to an ActionItem 43. The reference may be a URI or a local reference identifier (LRI). At “publication time” (described below), the actual ActionItem 43 replaces an ActionItemRef 31 or the URI is replaced by an LRI and a copy of the referenced ActionItem 43 is stored locally. This later case is useful when the ActionItem 43 is referenced by more than one ActionItemRef 31.

6. Palette 32—A Palette 32 contains a default ActionTarget 33 and a collection of ActionItemRefs 31. When the Palette 32 is destroyed, the contained ActionRefs 31 are also destroyed.

Palettes 32 are used by Composer 73 to manage previously defined ActionTargets 33 and ActionItems 43.

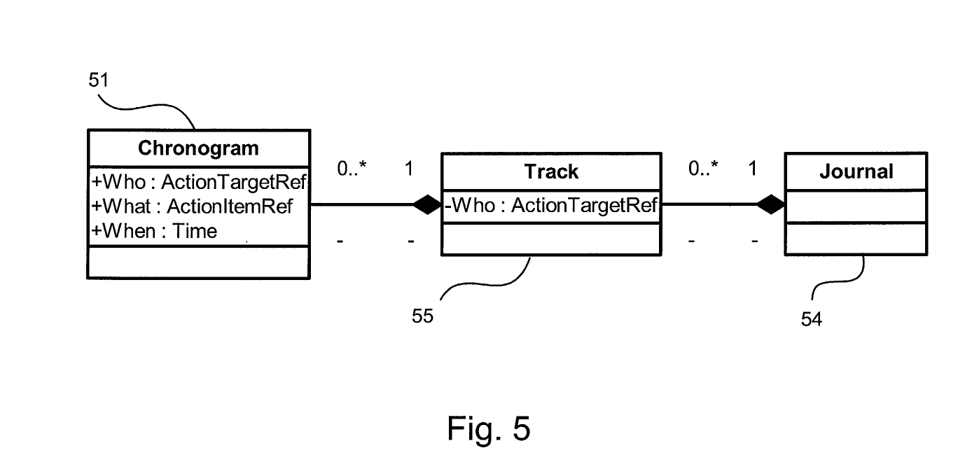

In FIG. 5, Chronograms 51, Tracks 55, and Journals 54 provide the fundamental synchronization concepts.

1. Chronogram 51—A Chronogram 51 is a three-tuple containing an ActionTarget 33, an ActionItemRef 31, and a Time 66. This is the fundamental element of synchronization.

2. Track 55—A Track 55 contains binding to an ActionTarget 33 and an ordered sequence of Chronograms 51, all referencing the same bound ActionTarget 33 and with monotonically increasing Times.

3. Journal 54—A Journal 54 contains one or more Tracks 55. Each contained Track 55 must be bound to a unique ActionTarget 33.

With the definition of a Journal 54, we now have the means to specify synchronization of different media to multiple ActionTargets 33.

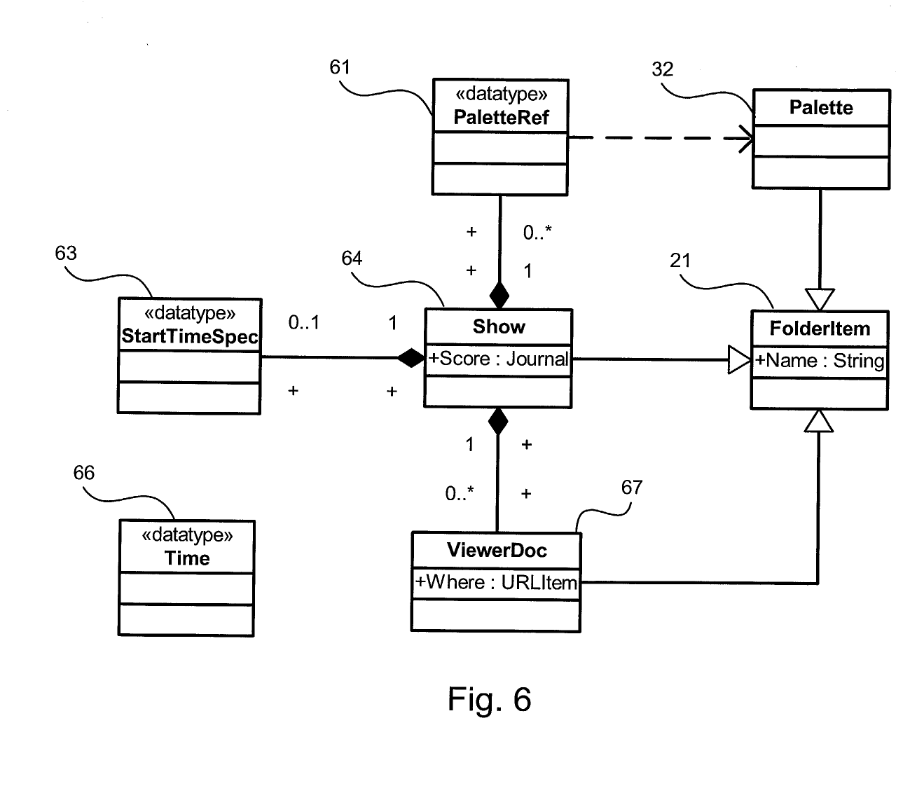

The final set of SynchroElements shown in FIG. 6 addresses the needs of both the composition process and the initial setup required at runtime to have a Journal 54 synchronize media across a set of ActionTargets 33.

1. PaletteRef 61—A PaletteRef 61 is a reference to a Palette 32.

2. ViewerDoc 67—A ViewerDoc 67 contains the initial bindings of ActionTargets 33. For example, associating an instantiated browser frame 37 or embedded media player 34 with the ActionTarget 33. The ViewerDoc 67 specifies then necessary steps to preparing the Viewer 95 for a synchronized media experience.

3. StartTimeSpec 63—A start time specification 63 denotes when a broadcast or webcast Show begins.

4. Show 64—A Show 64 contains a Journal 54, a collection of different ViewerDocs 67, a collection of StartTimeSpecs 63, and a collection of PaletteRefs 61 to support “drag and drop” Show composition.

A Show 64 is the output of the Composer 73 application and the SynchroElement acted upon by the Publisher 93.

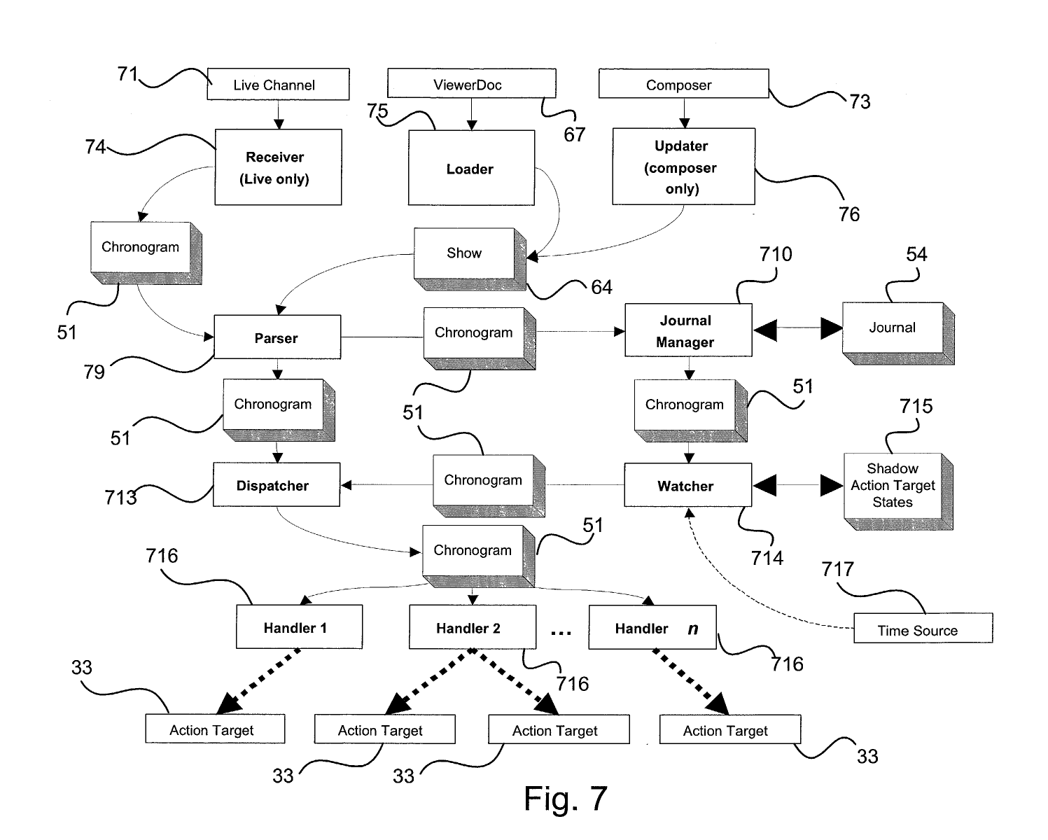

As shown in FIG. 7, SynchroOperators all reside within the Viewer 95 and realize the synchronized media experience by managing the SynchroElements and interfacing to the actual hardware or software described by the ActionTargets 33. Conceptually the SynchroOperators comprise a very simple media synchronization “virtual machine” that abstracts the specific implementations of the action targets and coordinates their operations.

1. Loader 75—Initializes the bindings to the ActionTargets 33 via the Handlers 716 and instantiates the other SynchroOperators.

2. Receiver 74—Receives Chronograms 51 on live multicast (or unicast) channel 71. The Chronograms 51 are immediately forwarded to the Parser 79. In a web browser, the preferred embodiment of the Receiver 74 is a Java applet that employs JavaScript callbacks.

3. Parser 79—The Parser 79 converts the stream-encoded Chronograms 51 into an in-memory element representation (such as the XML document object model or DOM) and passes the Chronograms 51 on to the Journal Manager 710. For “live” Shows, the Parser 79 immediately forwards the Chronogram 51 to the Dispatcher 713.

4. Journal Manager 710—Stores Chronograms 51 in the Journal 54. For a given action target 33 and time value, the Journal Manager 710 returns the most recent Chronogram 51 or null if none.

5. Time Source 717—Provided by either a media player or a real-time clock.

6. Watcher 714—Periodic background task that monitors the Journal 54 and the Time Source 717. Details of Watcher operator is described below.

7. Dispatcher 713—Inspects the Chronogram 51 and dispatches it to the appropriate handler 716, based on the Chronogram 51 type (pairing of ActionTarget 33 and ActionItemRef 31).

8. Handler 716—A Handler 716 is responsible for executing a particular Chronogram 51 type (for example, instructing a browser frame to load a new URL). Handlers 716 are “bound” to action targets 33 by the Loader 75. If the instantiated action target referenced in the ActionTarget 33 element doesn't exist or there is no command mapping for the Chronograms' 51 ActionItem 43, the Chronogram 51 is silently ignored.

9. Updater 76—The Updater 76 provides an external control interface for the case when the Viewer 96 is embedded in an enclosing application, in particular the Composer 73.

All Shows have an intrinsic elapsed time source 717, depending on the type of presentation. For instance, in a live Show 64, or one that is pre-recorded but being broadcast live, the show time is simply the “wall clock” time (from the clock built into the viewing device). On the other hand, for an on-demand show 64, the show time 717 is derived from the media position of the “principal media player” of the Show. It is important to understand that an on-demand presentation often allows for, and provides means for, the user to change the time position of this principal player to an arbitrary point within the presentation, and thereby skip to various portions of the presentation. Moreover, the user can typically pause, rewind, fast forward, etc.

The role of the Watcher 714 is to ensure that the state of each ActionTarget 33 is kept current with respect to the Show's 64 time source 717, despite the fact that this time source 717 can undergo unpredictable changes due, for instance, to user action as described above. For a particular Show 64, each ActionTarget 33 has a unique corresponding Track 55 within the Show's 64 Journal 54. A Track 55 specifies the time sequence of ActionItems 43 that are to be applied to a particular ActionTarget 33 in order to place the ActionTarget 33 into a particular sequence of states.

The Watcher 714 operates asynchronously from the Journal Manager 710, Parser 79, etc., as a real-time background task. At periodic intervals (e.g. once every 250 msec) it is awakens and samples the Show's 64 time source 717. It then consults each Track 55 to determine the appropriate state of the corresponding ActionTarget 33. The Watcher 714 then compares this state with the saved current state of the corresponding ActionTarget 33. If these two states differ, then the appropriate ActionItems 43 are dispatched in order to place the ActionTarget 33 into the current state.

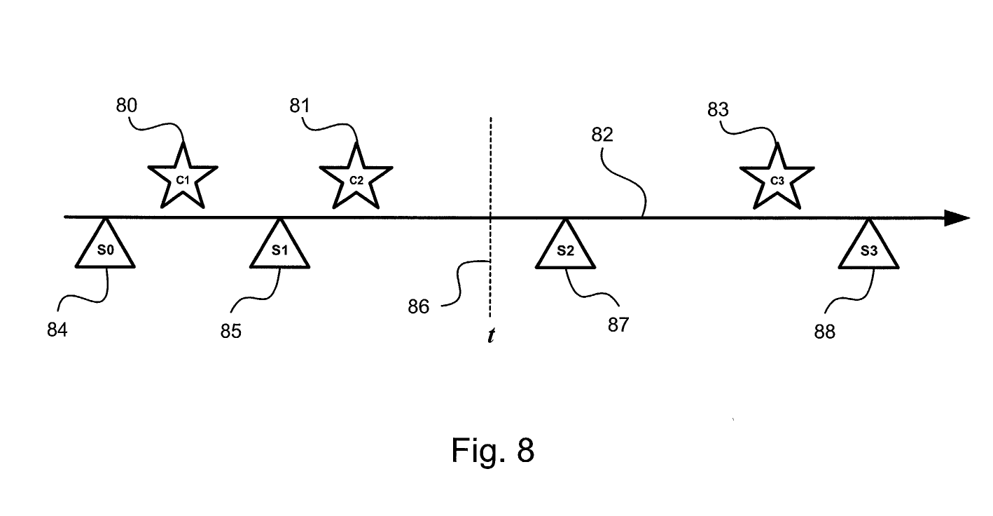

For example, FIG. 8 depicts a Track 55 as a timeline 82 on which ActionItems 43 (C1, C2, C3) 80, 81, 83 occur at particular discrete times. Between the occurrence of any two temporally adjacent ActionItems 43, the ActionTarget 33 is in a consequential fixed state (S0, S1, S2, S3) 84, 85, 87, 88. It is the role of the Handler 716 for a particular ActionItem 43 (e.g. C2) 81 to transition the ActionTarget 33 into the appropriate following state (e.g. S2) 87 given that the ActionTarget 33 is initially in the appropriate prior state (e.g. S1) 85. In many cases, the prior state is irrelevant to the Handler 716. In this example, the show's 64 time source 717 (t) 86 indicates that the ActionTarget 33 should be in the state (S2) 87. The Watcher 714 must issue the appropriate sequence of ActionItems 43 to place the ActionTarget 33 into this state. If the ActionTarget 33 is already in state (S2) 87 then no action need be taken.

A key consequence of the operation of the Watcher 714 is that the show's 64 time source 717 can skip forward or backward while still maintaining proper synchronization of the show's 64 ActionTargets 33.

The Tracks 55 that comprise the Journal 54 of a Show 64 can be played back through many different Viewers 95. These different Viewers 95 will have varying capabilities and more importantly, screen sizes. These differences will be handled by using device specific ViewerDocs 67. The ViewerDocs 67 will be selected and customized by the author, based on Viewer 95 capabilities.

The following subsections will cover, at a high level, how authors will use the SMS Composer 73 application.

1. ViewerDoc 67 Selection

The author must first create, reuse, or modify a ViewerDoc 67 appropriate for a target audience segment and an associated viewer 95 device. This ViewerDoc 67 will define how many and what type of ActionTargets 33 will be synchronized. Since multiple ViewerDocs 67 can be associated with a Show 64, the author would usually choose the ViewerDoc 67 with the most ActionTargets 33 to construct the Show 64. Subsequent ViewerDocs 67 can then be created or reused with this Show 64 to provide alternate synchronous media experiences to other target audiences and viewer 95 devices.

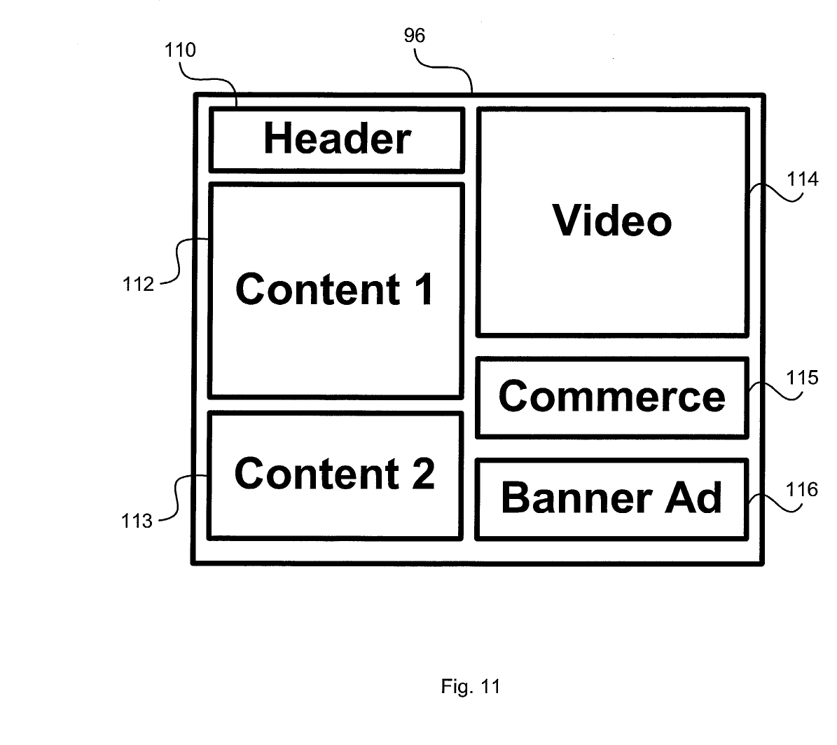

The sample template shown in FIG. 11 depicts what a ViewDoc 67 may look like when rendered within the Composer's 73 embedded Viewer 96. The video frame 114 is where a media player would play a video Track providing the primary timesource 717. In this case, the ViewerDoc 67 includes 5 ActionTargets 33 displayed as web browser frames.

The content frames 112, 113 are where the composer 73 can synchronize information content. The commerce frame 115 is where the composer can place product opportunities in a contextually sensitive manner and the banner frame 116 can contain contextually placed advertising. The content frames 112, 113 can also contain other interactive services such as chat windows, polling interfaces, etc.

Note that while the Composer 73 application may need to simulate a specific Viewer 96 along with its ActionTargets 33, it will produce the correct ViewerDoc 67 for the targeted Viewer 95, not for it's own simulation of that Viewer 96.

2. Composition Preparation

Before content, commerce and other components can be synchronized with a timeline, the author must prepare at least one synchronization Palette 32. A Pallet 32 is associated with a default ActionTarget 33 and contains a list of ActionItemRefs 31 that can be synchronized.

For example, in the case of commerce, the author may search an extensive list of products and choose the most suitable ones to contextually synchronize with a video. A product search screen could include a keyword search to allow authors to enter keywords related to the content of the video to help scope the product catalog to items of interest.

Similarly, the author can enter URL's of the informational content that they would like to synchronize in the various ActionTargets 33. The author continues choosing ActionItems 43 of each desired type, possibly including interactive chat or polling items, until all required ActionItems 43 for this Show 64 have been placed in a Palette 32.

3. Composition Process

Now that the author has chosen a ViewerDoc 67 and populated the Palettes 32, they are ready to synchronize a live event or an on-demand experience.

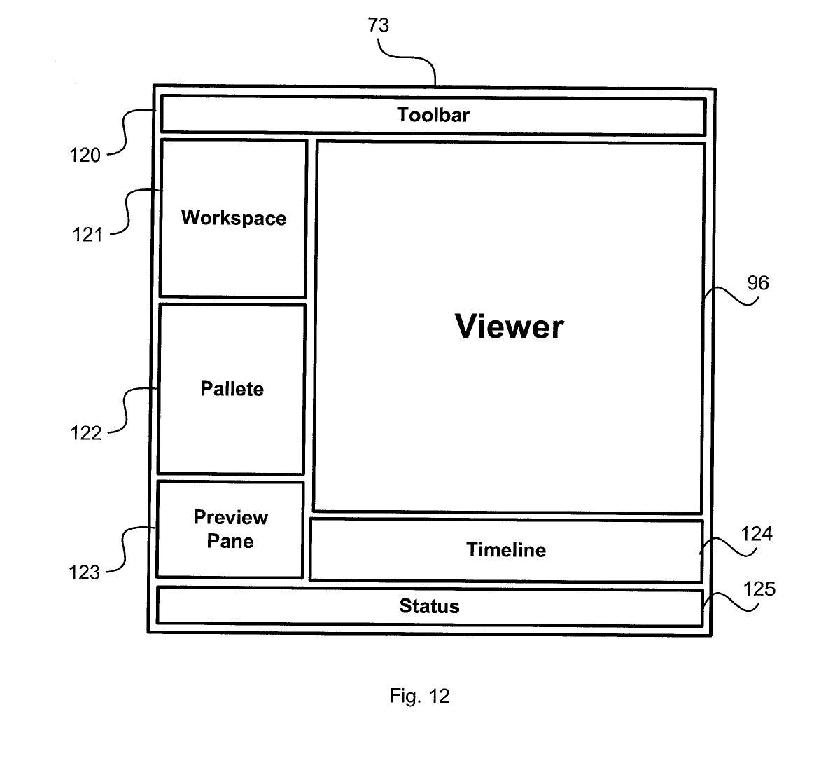

FIG. 12 conceptually depicts the Composer 73 user interface. On the upper left is the Workspace 121 and Palette 122 of items that may be synchronized. The lower left contains a preview pane 123 to display the selected ActionItem 43 prior to use. On the right is the embedded Viewer 96 simulating what the viewers 95 will see.

As an example, the composer will watch a pre-recorded video in the video frame 114, and simultaneously drag and drop ActionItems 43 from the Palette 122 into the frame representing the desired ActionTarget 33.

In the case of a live event, the all Viewers 95 will receive and present the ActionItems 43 within the appropriate ActionTargets 33 in real time as the author inserts them. The author will also see the ActionItems 43 presented in the embedded Viewer 96, so that author and audience are experiencing exactly the same media synchronization.

In the case of post-production synchronization, the author can stop, rewind, fast-forward and edit synchronization Tracks 55 at any time during the process.

4. Unique Composer User Interface Elements

The Composer user interface incorporates two more unique controls -the Workspace 121 window and the Timeline 124 window.

The Workspace 121 window contains a tree control that allows “collapse-expand” style navigation of a Workspace 24, including the FolderRefs 23 and all contained SynchroElements. Authors may modify the Workspace 24 via this control 121.

The Timeline 124 window provides a visualization of a Track 55. Icons are used to represent the ActionItems 43 sequenced in a track 55. The Timeline 124 can be scrolled horizontally and vertically as needed. The timescale can be adjusted through a dropdown control. In addition to the usual control operations (such as “cut”, “copy”, “paste”, “undo”, “redo”, etc.), the Timeline 124 control supports time-shifting (dragging) a single or multiple selection, and changing current media time (dragging the time cursor).

The SMS Publisher 93 coordinates the activities of various individual and composer 73 groups, and then publishes their created Shows 64 for distribution to viewer 95 communities. The SMS Publisher 93 is comprised of the following components:

1. Publisher Command Protocol

The Publisher 93 communicates with other applications (primarily the Composer 73) via a message-oriented protocol. This protocol is of a “request-response” type, and highly extensible.

In the preferred embodiment, the XML-based Simple Object Access Protocol (SOAP) is used as the foundational mechanism for the Publisher 93 Command Protocol. Thus any application or device that can format, parse, transmit, and receive HTTP-like requests with text payloads is suitable for communication with the Publisher 93.

2. SynchroElement Repository

The Palettes 32 and Shows 64 created by Authors represent valuable shared resources for the composers' 73 publisher 93. Just like shared records in a relational database, publishers 93 will want to safely store SynchroElements, control access to them, and back them up. In particular publishers 93 want to support coordinated, scalable, simultaneous usage of SynchroElements. The SynchroElement Repository provides these functions.

Coordinated usage is supported by defining a message-oriented command set containing verbs like “check out”, check in”, “snapshot”, “label”, “version”, “rollback”, etc. This command set is similar to those employed by source-code control systems. The Publisher 93 provides access to the SynchroElement Repository as governed by the author profiles defined in the Publisher Directory described below.

3. Publisher Directory

The Publisher Directory is a hierarchical tree structure storing entities and their associated attribute values. The Publisher Directory contains passwords, access rights, and locator information relating composers, composer groups, and SynchroElements. The Publisher Directory can also store definitions of various viewers and viewer communities, their SMS Viewer 95 capabilities, demographics, interaction history, subscriptions, and personal preferences.

4. Show Publication

The Publisher Console is client application of the Publisher 93 that provides access to the publish command set of the Publisher 93. These commands “publish” Shows 64 from the SynchroElement Repository to Distributors 94. Various Distributors 94 can be listed in the Publisher Directory. As an “economy” grows around the Synchronous Media System, these entries may automatically be exchanged by a number of emerging XML-based business directory and content syndication protocols. Distributor 94 location, access control information, distribution capabilities, and contract parameters can be stored in the Publisher Directory.

Publication can be a fairly involved process of preparing Shows 64 for distribution to a wide variety of SMS Viewer 95 types and a wide variety of viewer communities. For example, the Show 64 might be translated from XML into JavaScript, default commerce items may be replaced by regional alternatives, English text may be replaced by known language preferences, etc.

5. Support for Live Shows 64

For live Shows 64, the Publisher forwards ActionItems 43 to the established distribution channels as Composers 73 place them on Tracks 55. The Publisher 93 also records the live Show's 64 Tracks 55 for later playback or rebroadcast.

The SMS Distributor 94 is responsible for managing Show 64 storage, usage, and lifetime. These functions are critical because a Show 64 can be used in a wide variety of business relationships. For example, Shows can be:

a. Education or entertainment vehicles with purchase or pay-per-experience economic models

b. Free education or entertainment vehicles with contextual commerce opportunities

c. On-demand experiences, broadcasts, or webcasts

d. Available for use to a particular distributor or viewer community within only a limited time window

e. Monetized by paying royalties to both Show publishers and/or content providers

To support this wide range of relationships the Distributor 94 includes the following functionality:

1. Distributor Command Protocol

Similar to the Publisher Command Protocol, the Distributor 94 supports and XML-based command protocol that employs a messaging paradigm. Again, the preferred embodiment is SOAP over HTTP.

2. Distributor Console Application

The Distributor Console Application provides access to the Distributor 94 Command set and a graphical user interface to visualize interaction with the repository, syndication, and live distribution activities described below.

3. Distributor Show Repository

The Show Repository catalogs all resident shows 64. The Show Repository exposes an extensive query capability allowing distribution managers to manage their Show 64 inventory, including the ability to archive or discount seldom used or expired Shows 64, create Show 64 packages and special offers, verify the validity of Shows 64 (checking for broken media links, revised commerce opportunities, etc.).

The Show Repository also contains extensive viewer and viewer community statistics relating to Shows 64, such as viewing habits (time-of-day, day-of-the-week, etc.), affinities (viewing one Show 64 raises probability of viewing another), commerce activity during viewing (a Show's 64 ability to generate revenue), repeat viewing, and so on.

4. Show Syndication Engine

Many vendors are offering extensive media syndication infrastructures. The Show Syndication Engine is meant to complement media syndication services by a parallel and integrated mechanism for syndicating SMS Shows 64.

Syndication generally has two types of modes—“push” and a “pull”. In “push” mode, a distributor subscribes to content and it is automatically delivered by schedule or by event (e.g., new content published). In “pull” mode the distributor only subscribes to a catalog that is delivered by push mode. The distributor then selects (manually or programmatically) the desired content and pulls it from the syndicator (again, manually or programmatically).

The SMS Show Syndication Engine operates in a parallel fashion supporting both push (whole Shows) and pull (Show catalogs only) modes. The underlying mechanism can be a standard media syndication engine. Once a distributor accepts a Show 64, the underlying media syndication infrastructure can be used to pull the Shows 64 associated content, if the distributor desires to serve both Shows and content.

The Distributor Console Application provides visual interaction with the syndication process—browsing of Show 64 catalogs, preview of associated media (via an embedded Viewer), acceptance of syndication shipment, unpacking for Repository storage, payment resolution, etc.

The Distributor Console can also support “downstream” syndication—Offer creation, package generation, delivery parameters (HTTP, SSL, FTP, retries, etc.), process control (monitoring, management, tracking).

Since media syndication infrastructures provide foundational services for most of this functionality, the Show Syndication Engine need only provide the additional semantics and operations to extend syndication to SMS Shows 64.

5. Chronogram Router

The Distributor 94 plays a key role in the distribution of live shows 64 to very large audiences. The Distributors 64 for a “virtual network” of application level “routers” for the delivery of Chronograms 51. The live distribution is described in the following section.

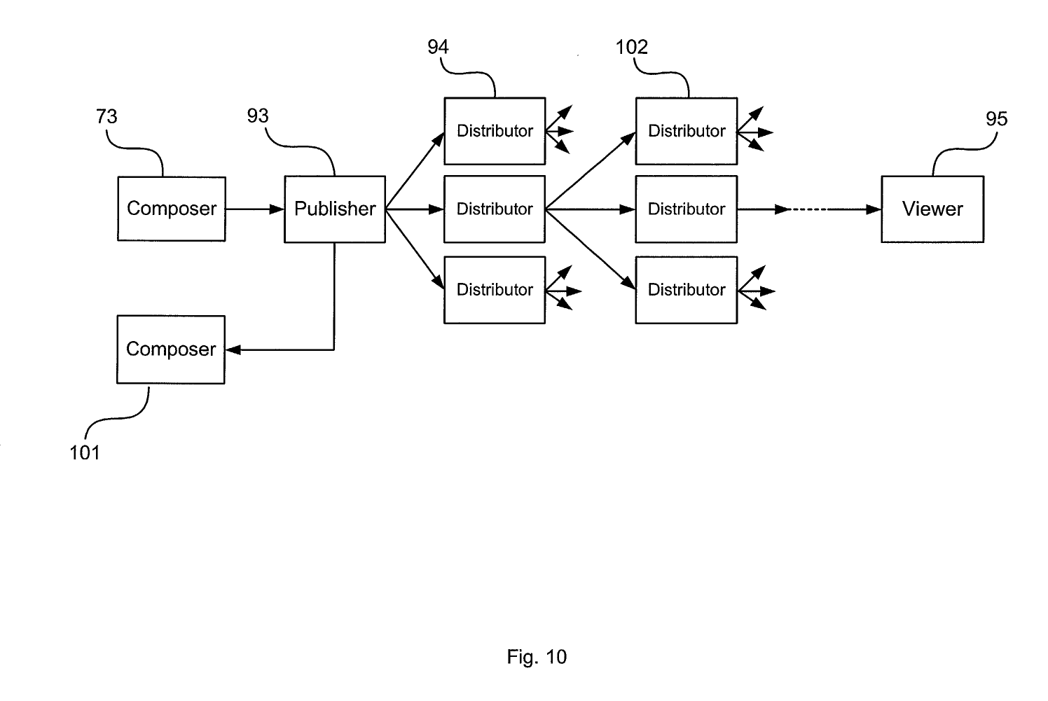

Live synchronization requires a real-time data stream to instantly update the Viewer 95 screens as soon as it is updated in the Composer 73 interface. FIG. 10 illustrates Live Show Distribution:

The following sequence describes Live Show Distribution:

a. The author drags an ActionItem 43 onto a Track 55 while monitoring a live media stream.

b. The Composer 73 creates the appropriate Chronogram 51 and forwards it on to its embedded Viewer 96.

c. The Composer's 73 embedded Viewer 96 stores it in the local version of the Show 64.

d. The embedded Viewer 96 then forwards the Chronogram 51 to the appropriate Handler 716 (often this will update a portion of the display with new content).

e. The Composer 73 forwards this Chronogram 51 on to the Publisher 93.

f. The Publisher 93 stores the Chronogram 51 in its cached version of the Show 64.

g. The Publisher 93 forwards the Chronogram 51 on to any simultaneously attached Composers 101.

h. The Publisher 93 forwards the Chronogram 51 on to any Distributors 94 established as part of the live synchronization virtual network.

i. The simultaneously attached Composers 101 receive the Chronogram 51 and update their local versions of the Show 64 and forward to their Handlers 716.

j. The virtually networked Distributors 94 receive the Chronogram 51 and update their local versions of the Show 64.

k. The Distributor 94 forwards the Chronogram 51 to any configured downstream Distributors 102.

l. The Distributors 102 forward the Chronogram 51 on to connected Viewers 95 which process the Chronogram 51 as described above.

m. Any Viewers 95 joining the Show 64 in progress receive the cached version of the Show 64 from their connected Distributor 102.

In forwarding Chronograms 51, the preferred transport embodiment is a TCP/IP multicast stream for all clients that are behind an ISP that supports multicast. For less fortunate Viewers 95 the Chronograms 51 are forwarded via a unicast stream. Multicast technology enables all Viewers 95 of a live Show 64 to share the same stream rather than having a unique individual stream for each client. Multicast capabilities at ISP's are growing at an impressive rate and soon, most end users will be able to receive a multicast stream.

Until multicast is available on for all Viewers 95, unicast must still be supported. Unicast is much more demanding of the Distributor 102 because every unicast Viewer 95 needs its own connection. To achieve scalability in a unicast environment, Distributors 102 can be connected in a logical tree network. Distributors 102 can forward on Chronograms 51 much like a TCP/IP router forwards on IP datagrams.

The content provider systems 91, 92 are included in the SMS architecture diagram in FIG. 9 to illustrate how they are used in conjunction with the Composer 73 and Viewer 95. The two servers shown at right are the media streaming server 92 and the web content serve 91r. These will be discussed briefly below.

1. Media Streaming Server 92

The streaming server 92 is external to the SMS Server environment. The content providers stream their own audio or video either themselves or through partners.

The media stream itself, for both live and on-demand, will be viewed in the SMS Composer 73 interface allowing the publisher to view and synchronize acquired video. When the video is streamed to the Viewer 95, the stream originates from the content providers systems and not from the Publisher 93. Shows 64 are independent of any synchronized media.

2. Web Content Server 91

The web content server 91 is also external to the SMS. The content provider hosts their own web content either themselves or through partners.

The web content itself, for both live and on-demand, will be viewed in the SMS Composer 73 interface allowing the author to view and synchronize content with the video. When the content is displayed to the Viewer 95, the content originates from the content provider's systems and not from the Publisher 93.

Thus, as can be seen from the foregoing, by separating the time synchronization data from each of the presentation media data, many advantages are obtained. Further, by linking to each of the presentation media data where the provides only a link to the content thereof, greater flexibility to change the content is achieved.

What is claimed is:

1. A method of creating a plurality of different media data from a plurality of presentation media data for use in the presentation of a time synchronized multimedia presentation, said method comprising:
separating time synchronization data from each of said plurality of presentation media data; and
creating links to each of said plurality of presentation media data for each of said plurality of different media data, wherein said links to each of said plurality of presentation media data provides only a link to the content thereof.

2. The method of claim 1 wherein said separating step separates time synchronization data into one or more independent time sequences of actions.

3. The method of claim 1 wherein said separating step separates time synchronization data into one or more independent time sequences of references to actions

4. The method of claim 1 further comprising:
viewing the presentation of said time synchronized multimedia presentation coincident with said creation of said plurality of different media data.

5. The method of claim 1 further comprising:
viewing the presentation of said time synchronized multimedia presentation after said creation of said plurality of different media data.

6. A computer product comprising:
a computer usable medium having computer readable program code embodied therein for use with a computer for creating a plurality of different media data from a plurality of presentation media data for use in the presentation of a time synchronized multimedia presentation;
computer readable program code configured to cause said computer to separate time synchronization data from each of said plurality of presentation media data; and
computer readable program code configured to cause said computer to create links to each of said plurality of presentation media data for each of said plurality of different media data, wherein said links to each of said plurality of presentation media data provides only a link to the content thereof.

7. The computer product of claim 6 further comprising:
computer readable program code configured to cause said computer to separate time synchronization data into one or more independent time sequences of actions.

8. The computer product of claim 6 further comprising: computer readable program code configured to cause said computer to separate time synchronization data into one or more independent time sequences of references to actions.

9. The computer product of claim 6 further comprising:
computer readable program code configured to cause said computer to permit viewing of the presentation of said time synchronized multimedia presentation coincident with said creation of said plurality of different media data.

10. The computer product of claim 6 further comprising:
computer readable program code configured to cause said computer to permit viewing the presentation of said time synchronized multimedia presentation after said creation of said plurality of different media data.

11. A plurality of different media signals stored on a server to be transmitted therefrom for use in the presentation of a time synchronized multimedia presentation, each of said plurality of different media signals comprising:
a content link signal for linking the associated media signal to an associated presentation media signal wherein said control link signal provides only a link to the content of said associated presentation media signal; and
a synchronization signal, wherein said synchronization signal being a time synchronization signal for the associated presentation media signal.

12. The signals of claim 11 wherein said synchronization signal separates one or more independent time sequences of actions.

13. The signals of claim 11 wherein said synchronization signal separates one or more independent time sequences of references to actions.

14. The signals of claim 13 wherein said actions are organized hierarchically.

15. The signals of claim 14 wherein the hierarchy consists of folders and workspaces.

16. The signals of claim 15 wherein said folders contain reference to actions.

17. The signals of claim 11 further comprising a control signal for controlling the access to the associated presentation media signal.

18. The signals of claim 11 wherein each signal is in an XML format.

19. A method of creating a plurality of different media data from a plurality of presentation media data and presenting a time synchronized multimedia presentation thereof, said method comprising:
separating time synchronization data from each of said plurality of presentation media data;
creating links to each of said plurality of presentation media data for each of said plurality of different media data, wherein said links to each of said plurality of presentation media data provides only a link to the content thereof;
presenting a time synchronized multimedia presentation from said plurality of different media data by:
retrieving the content from said plurality of presentation media data based upon the links from said plurality of different media data; and
presenting said content retrieved based upon the time synchronization data separated from each of said plurality of presentation media data.

20. The method of claim 19 wherein said presenting step comprises a browser executing a runtime scripts.

21. The method of claim 19 wherein said separating step separates the synchronization data into one or more independent time sequences of actions (hereinafter: “tracks”).

22. The method of claim 21 further comprising:
monitoring the tracks to ensure that said time synchronized multimedia presentation is kept current, despite changes in the current time.

23. The method of claim 21 further comprising:
monitoring the tracks to ensure that said time synchronized multimedia presentation is kept current, despite concurrent changes in the synchronization data.

24. A computer product comprising:
a computer usable medium having computer readable program code embodied therein for use with a first computer for creating a plurality of different media data from a plurality of presentation media data and for presenting a time synchronized multimedia presentation;
computer readable program code configured to cause said first computer to separate time synchronization data from each of said plurality of presentation media data; and
computer readable program code configured to cause said first computer to create links to each of said plurality of presentation media data for each of said plurality of different media data, wherein said links to each of said plurality of presentation media data provides only a link to the content thereof; and
computer readable program code configured to cause a second computer to present a time synchronized multimedia presentation from said plurality of different media data by:
retrieving the content from said plurality of presentation media data based upon the links from said plurality of different media data; and
presenting said content retrieved based upon the time synchronization data separated from each of said plurality of presentation media data.

25. The computer product of claim 24 further comprising:
computer readable program code configured to cause said second computer to derive a reference for time synchronization from the current position of a portion of said plurality of presentation media data.

26. The computer product of claim 24 further comprising:
computer readable program code configured to cause said second computer to derive a reference for time synchronization according to a schedule.

27. The computer product of claim 24 further comprising:
computer readable program code configured to cause said second computer to derive a reference for time synchronization from the computer system clock.

28. The computer product of claim 24 further comprising:
computer readable program code configured to cause said first computer to separate time synchronization data into one or more independent time sequences of actions (hereinafter: “tracks”).

29. The computer product of claim 24 further comprising:
computer readable program code configured to cause said first computer to separate time synchronization data into one or more independent time sequences of references to actions.

30. The computer product of claim 24 further comprising:
computer readable program code configured to cause said first computer to permit viewing of the presentation of said time synchronized multimedia presentation coincident with said creation of said plurality of different media data.

31. The computer product of claim 28 further comprising:
computer readable program code configured to cause said first computer to permit viewing the presentation of said time synchronized multimedia presentation after said creation of said plurality of different media data.

32. The computer product of claim 28 further comprising:
computer readable program code configured to cause said computer to monitor the tracks to ensure that said time synchronized multimedia presentation is kept current, despite changes in the current time.

33. A computer network system comprising:
a first computer for creating a plurality of different media data from a plurality of presentation media data and having a first computer program code for separating time synchronization data from each of said plurality of presentation media data and wherein said first computer program code for linking each of said plurality of presentation media data for each of said plurality of different media data, wherein said links to each of said plurality of presentation media data provides only a link to the content thereof;
a second computer for presenting a time synchronized multimedia presentation from said plurality of different media data and having a second computer program code for retrieving the content from said plurality of presentation media data based upon the links from said plurality of different media data; and wherein said second computer program code for presenting said content retrieved based upon the time synchronization data separated from each of said plurality of presentation media data; and
a communication network linking said first computer with said second computer.

34. The computer network of claim 33 wherein said second computer is in a wireless device and wherein said communication network is a wireless network.

35. The computer network of claim 33 wherein said second computer is in a TV set-top box.

36. The computer network of claim 35 wherein said second computer communicates with said first computer in accordance with the ATVEF protocol.

37. A method of delivering a plurality of different media data from a plurality of presentation media data and presenting a time synchronized multimedia presentation thereof, said method comprising:
storing time synchronization data separate from each of said plurality of presentation media data;
storing links to each of said plurality of presentation media data for each of said plurality of different media data, wherein said links to each of said plurality of presentation media data provides only a link to the content thereof;
delivering a time synchronization data and links to a plurality of users;
presenting a time synchronized multimedia presentation from said plurality of different media data by to said plurality of users, by each user:
retrieving the content from said plurality of presentation media data based upon the links stored; and
presenting said content retrieved based upon the time synchronization data stored.

38. The method of claim 37 wherein said delivering is done in real time.

39. The method of claim 37 wherein said delivering is done on demand.

40. The method of claim 37 wherein said delivering is done pursuant to an XML based command protocol.

41. The method of claim 37 wherein said delivery is done pursuant to an IP multicast format.

42. The method of claim 37 wherein said delivery employs a logical tree network of point-to-point connections.

43. The method of claim 37 further comprising controlling and visualizing distribution activities.

44. A computer product comprising:
a computer usable medium having computer readable program code embodied therein for use with a computer for storing a plurality of different media data from a plurality of presentation media data and delivering and presenting a time synchronized multimedia presentation;
computer readable program code configured to cause said computer to store time synchronization data separate from each of said plurality of presentation media data; and
computer readable program code configured to cause said computer to store links to each of said plurality of presentation media data for each of said plurality of different media data, wherein said links to each of said plurality of presentation media data provides only a link to the content thereof; and
computer readable program code configured to cause said computer to present a time synchronized multimedia presentation from said plurality of different media data by:
retrieving the content from said plurality of presentation media data based upon the links stored; and
presenting said content retrieved based upon the time synchronization data stored.

45. A computer network system comprising:
a server computer for storing a plurality of different media data from a plurality of presentation media data and having a first computer program code for storing time synchronization data separate from each of said plurality of presentation media data and wherein said first computer program code for storing links to each of said plurality of presentation media data for each of said plurality of different media data, wherein said links to each of said plurality of presentation media data provides only a link to the content thereof;
a client computer for presenting a time synchronized multimedia presentation from said plurality of different media data and having a second computer program code for retrieving the content from said plurality of presentation media data based upon the links from said plurality of different media data; and wherein said second computer program code for presenting said content retrieved based upon the time synchronization data separated from each of said plurality of presentation media data; and
a communication network linking said server computer with said client computer.

46. The computer network of claim 45 wherein said second computer is in a wireless device and wherein said communication network is a wireless network.

47. The computer network of claim 45 wherein said second computer is in a TV set-top box.

48. The computer network of claim 45 wherein said second computer communicates with said first computer in accordance with the ATVEF protocol.
